(19) United States
(12) Patent Application Publication
(10) Pub. No.: US 2025/0216509 A1
(43) Pub. Date: Jul. 3, 2025

(54) SIGNAL DELAY CIRCUIT AND RADAR SIMULATOR COMPRISING SUCH DELAY CIRCUIT

(71) Applicant: Rohde & Schwarz GmbH & Co. KG, Munich (DE)

(72) Inventors: Maximilian BOGNER, Munich (DE); Steffen NEIDHARDT, Dorfen (DE); Gerhard HAMBERGER, Griesstaett (DE); Matthias BEER, Neubiberg (DE)

(21) Appl. No.: 18/924,645

(22) Filed: Oct. 23, 2024

(30) Foreign Application Priority Data
Dec. 28, 2023 (DE) 10 2023 136 747.1

(51) Int. Cl. G01S 7/40; G01S 7/41; G01S 13/76

(52) U.S. Cl. CPC G01S 7/4065; G01S 7/4021; G01S 7/4056; G01S 7/41; G01S 13/767

(57) ABSTRACT

A delay circuit comprises a receiver for an incoming signal, a limiting amplifier, configured to receive and process the incoming signal, a fixed delay line configured to introduce a predetermined time delay to the signals down-or-up-stream the power controlling circuit.

A radar target simulator system using such delay circuit may provide a simulated radar target response by introducing a controlled time delay and amplitude limitation to said incoming signal.

### RELATED APPLICATION

This application claims the benefit of priority from German Patent Application No. 10 2023 136 747.1, filed on Dec. 28, 2023, the contents of which are incorporated herein by reference in its entirety.

### TECHNICAL FIELD

The present disclosure relates to a signal delay circuit which may find application, among others, e.g. in a target simulator e.g. for testing radar sensors or other ranging sensors.

### BACKGROUND ART

In essence, a radar test system is a technological platform designed to evaluate, validate, and improve the performance of radar sensors, which serve as the device-under-test (DUT). Radar sensors, often utilizing radio waves, play a pivotal role in a wide range of industries due to their ability to provide precise distance measurements and create detailed 3D representations of the environment. Radar systems are engineered with versatility as a central focus, aiming to accommodate a wide range of uses such as autonomous vehicles, automated manufacturing, aviation, surveillance, and environmental monitoring among others.

Key attributes of radar systems include their ability to perform multi-wave scanning, real-time data processing, and adaptability to diverse environmental conditions. Notably, these radar systems offer extended range capabilities, allowing real-time data collection over considerable distances, spanning hundreds of meters. This capability makes them particularly suitable for large-scale mapping projects and proactive obstacle detection in the field of autonomous driving. Moreover, radar systems frequently incorporate advanced software components that enable in-depth data analysis and seamless integration with other sensor inputs in an antenna array.

In a significant advancement, radar test systems have the dynamic ability to simulate the presence of moving objects, such as pedestrians and vehicles. This functionality holds substantial practical importance as it allows for a comprehensive assessment of a radar system's performance in detecting and tracking objects. The convergence of precise mapping, calibration, adaptability to real-world conditions, and advanced data processing positions this technology as an asset in our contemporary technological landscape.

U.S. Pat. No. 6,346,909B1 discloses a system that generates simulated radar targets eliminating the need for large outdoor test ranges and providing complex targets at specific dimensions and distances by using a multi-tap delay device and fiber optic delay.

Advanced navigation and positioning systems rely on radar simulators that must adeptly manage an extensive range of signal amplitudes, encompassing both feeble and robust signals. The key challenge here is to engineer these simulators to faithfully reproduce the intricate and diverse radar return signals encountered in real-world scenarios. In such scenarios, targets vary in distance and exhibit distinct reflective properties, demanding a simulator that can replicate these complexities accurately.

Moreover, these radar systems must seamlessly synchronize and integrate multiple input signals, particularly when operating alongside large antenna arrays. Ensuring that these signals harmonize without interference represents a formidable technical challenge.

To add to this complexity, achieving reliable delays in the radar signals requires not only coordination but also future-proofing with modular components compatible with diverse input receiver types, including also electro-optical conversion for optical ranging signals.

Signal delay circuits also find application in other frameworks than radar signals. The can find application in other ranging or non-ranging applications. E.g. communication systems some-times need to synch with a delay for example. Delay circuits can also be used to create reverb, phasing, etc. In computing, a delay line can help to synch operations of different parts of processors or operations.

### SUMMARY

The goal is to develop a versatile signal delay circuit.

These and other objectives are achieved by the embodiments provided in the enclosed independent claims. Advantageous implementations of the embodiments of the present disclosure are further defined in the dependent claims.

According to a first aspect, the present disclosure relates to a delay line circuit, comprising a receiver for an incoming signal, e.g. a ranging sensor or generally a radar, sonic, photonic, RF and/or LiDAR, a limiting amplifier, configured to receive and process the incoming signal, a fixed delay line configured to introduce a predetermined time delay to the received signal, wherein the signal delay circuit is adapted to introduce a controlled time delay and amplitude limitation to said incoming signal.

This has the technical advantage that the delay circuit uses cost-effective and modular components. The use of limiting amplification in the signal path ensures that the dynamic range of the received input signal can be very high (several tens of dB).

In an implementation form of the first aspect, the delay circuit comprises an attenuator or a further amplifier downstream the fixed delay line, and preferably controlled to reestablish the original signal power of the incoming signal.

The control of the attenuation provides the technical advantage that it has a good linearity over a wide amplitude (several tens of dB) and frequency range (several GHz) and creates less broadband noise than for instance amplification of the signal.

In an implementation form of the first aspect, the fixed delay line includes a PCB structure, coaxial cable or fiber.

In the framework of using the invention in the context of a radar or Lidar target simulator, for short simulation distances (less than a few meters), employing cost-effective and adaptable coaxial delay lines is advantageous, while for longer distances (greater than a few meters), electro-optical delay versions are recommended. Moreover, when dealing with several meters, the signal attenuation in coaxial delay lines becomes excessive, and fiber-based delay elements are preferred due to their minimal losses over very long distances (kilometers). For instance the use of SFP (Small Form-Factor Pluggable) fiber modules is an advantageous tool for precise delay generation in optical radar systems, facilitating accurate testing and signal synchronization and making the radar target simulator more versatile and extendable.

In an implementation form of the aforementioned aspects, the signal delay circuit contains a limiting amplifier which is adapted to limit the amplitude of the incoming signal over a wide range.

Limiting amplification is in this example a safeguard against over amplifying the received radar signals. If the amplification is set too high, it can cause signal distortion, saturation, and potentially damage the radar receiver. On the other hand, insufficient amplification can lead to weak or noisy signals, making it difficult e.g. to detect and accurately measure the radar cross section of the target when applying the invention to a Radar target simulator.

The appropriate level of output signal is determined based on the expected radar cross section of the target and the radar target simulators operational parameters. It's essential to strike a balance to ensure that the received radar signals are strong enough for accurate target detection and measurement but not so strong that they become distorted or saturate the receiver.

In an implementation form of the aforementioned aspects, the signal delay circuit comprises a controller configured to adjust the time delay and amplitude limitation parameters based on user-defined input to simulate various radar target scenarios.

In case of the application “radar target simulator”, adjusting for instance the time delay in a radar target simulator allows the operator to precisely mimic the target's distance or range from the radar system. By controlling the time delay, the simulator can replicate the time it takes for the radar signal to travel to the target and back, effectively emulating the target's range. This is essential for simulating objects at different distances or for generating moving targets.

Amplitude limitation control for example enables the simulator to replicate the radar cross-section or radar reflection characteristics of the target. In real-world scenarios, radar targets have different radar cross-section values, meaning they reflect radar signals with varying strengths. The simulator can adjust the amplitude of the simulated radar return to match the specific target's radar cross-section. This is crucial for accurately emulating how different objects appear on a radar screen. It is thus advantageous to employ automatic gain control techniques to adjust the amplification dynamically, ensuring optimal signal strength and quality for radar cross section analysis.

In an implementation form of the first aspect, the signal delay circuitry further comprises a frequency divider downstream the fixed delay line.

In an implementation form of the third aspect, the signal delay circuit comprises an opto-electronic converter prior to and after a fiber delay.

Integrating opto-electronic converters within the radar target simulator not only offers the advantage of using more reliable optical delays for longer distances (greater than a few meters) but also extends the potential for working with light-based signals, such as LiDAR, as an illustrative example. By combining the complementary strengths of both technologies, such as LiDAR's high-resolution 3D mapping capabilities and radar's all-weather and long-range detection, an integrated system offers a comprehensive and accurate solution. The synergy between LiDAR and radar enhances the system's capacity to track and identify objects, whether in challenging weather conditions or diverse terrains. Moreover, the fusion of LiDAR and radar data allows for improved object classification and situational awareness, enabling more informed decision-making and enhancing safety in a wide range of scenarios.

In an implementation form of the aforementioned aspects, the radar target simulator system further comprises multiple delay lines in the delay circuit and a switch for selecting the delay.

Switching between various delay lines offers the technical advantage of providing flexibility in the delay configuration and multiple options also, for instance, for selecting a series of delays.

In an implementation form of the before mentioned aspect, the short delay lines of the radar target simulator system are coaxial and the long delay lines are fiber-based.

For short simulation distances, typically less than a few meters, coaxial delay lines present an advantageous solution. They are not only cost-effective but also highly adaptable to different scenarios. However, when dealing with longer distances, surpassing a few meters, it becomes essential to consider electro-optical delay versions. These offer improved performance and precision, particularly for larger distances where signal attenuation in coaxial delay lines can become problematic. In fact, when working with several meters or over very long distances, on the order of kilometers, fiber-based delay elements emerge as the preferred choice due to their minimal signal losses, ensuring the integrity of the transmitted data. The selection of the appropriate delay line is thus tailored to the specific requirements of the application, balancing cost-effectiveness, adaptability, and signal fidelity.

In an implementation form of the aforementioned aspects, the target simulator applies a frequency shift to a return signal.

This implementation is particularly advantageous for Frequency-Modulated Continuous Wave (FMCW) radar and Doppler radar setups. The frequency shift plays a crucial role in target detection and velocity measurement. In FMCW radar, a linear frequency sweep is transmitted, and the frequency shift between the transmitted and received signals is used to determine the range or distance to a target. When the received signal is mixed with the trans-mitted signal, the resulting beat frequency is proportional to the round-trip time taken by the radar signal, which can be translated into target range information. In Doppler radar, the frequency shift is employed to detect the velocity of moving targets. As objects in motion cause a shift in the frequency of the reflected radar signal due to the Doppler effect, this frequency shift is measured to ascertain the target's speed. Overall, the application of a frequency shift is an important feature of a radar target test system, enabling the measurement of both distance and velocity.

In an implementation form of the first aspect, each object to be simulated has a separate delay line.

The technical advantage lies in the fact that each object's specific distance or hardware-defined delay serves in this example as a distinctive signature, enabling the radar system to distinguish among multiple targets and accurately pinpoint their positions. This differentiation in delay guarantees that the radar can recognize and separate various objects, even if they are in close proximity or overlapping within the radar's scanning area. This capability is instrumental in providing real-time spatial data about objects with varying delays, including those that may be in motion.

In an implementation form of the first aspect, the radar target simulator system comprises multiple channels of the antenna array that can multiplex into the same delay line.

One significant advantage of the cooperation of a radar target system with antenna arrays is their multiplexing capability, which allows them to handle multiple tasks or delays simultaneously. Antenna arrays, equipped with multiple modular elements that can be individually controlled, offer the flexibility to direct beams of electromagnetic energy in various directions and shapes. This means they can perform multiple functions concurrently, such as tracking multiple targets, providing spatial diversity for enhanced radar reliability, and implementing beamforming to focus energy on specific areas of interest. In the context of radar target test systems, this multiplexing ability enables enhanced performance, increased capacity, and improved efficiency, making antenna arrays a valuable extension, for instance, for MIMO (Multiple-Input, Multiple-Output) channeling into the delay circuits.

In an implementation form of any of the preceding aspects, the radar target simulator system further comprises a mixer to adapt the frequencies as a downconverter and upconverter from the intermediate frequency path.

This implementation is in particular advantageous for the radar target system to operate at various (especially higher) frequency bands, making them adaptable to different applications. Mixers are instrumental in enhancing the frequency capabilities of radar systems, allowing them to handle a wide range of frequencies for target detection and signal processing. For example, a mixer can assist in improving the performance of analog-to-digital converters (ADCs) by converting signals to lower intermediate frequencies, which are easier to digitize with high resolution. Moreover, a mixer can be employed in signal generation by combining different frequencies or modulating signals, enabling radar target systems to transmit diverse waveforms and adapt to the specific operational requirements for instance of the antenna array.

### BRIEF DESCRIPTION OF THE DRAWINGS

The above described aspects and implementation forms of the present disclosure will be explained in the following description of specific embodiments in relation to the enclosed drawings, in which:

FIG. 1 shows a circuit diagram of a delay circuit e.g. for a radar target simulator,

FIG. 2 shows schematically a vehicle radar test setup, and

FIG. 3 shows a scheme of a radar target simulation setup being one use example for the invention.

### DETAILED DESCRIPTIONS OF EMBODIMENTS

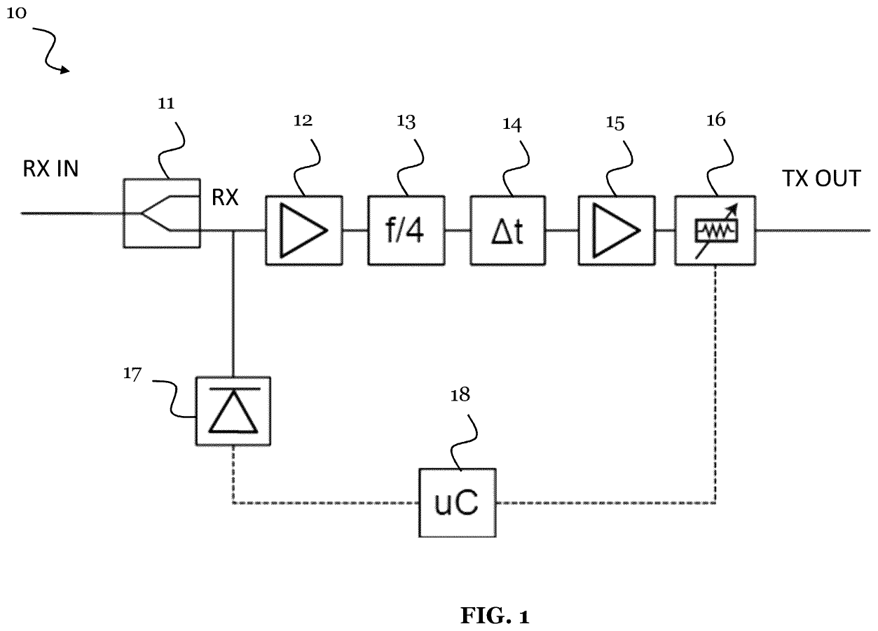

FIG. 1 shows a schematic of a delay circuit e.g. for a radar target simulator 10, with a splitter for the received signal (RX) 11, a limiting amplifier 12, a frequency divider 13, a fixed delay line 14, a limiting amplifier 15, a variable attenuator 16, a power detector 17 and a controller 18.

Although the invention will be explained in the framework “radar simulation”, it is to be understood that the invention may equally find application in other fields e.g. of telecommunication, computing etc.

According to one embodiment the received signal (RX) is conditioned by the first limiting amplifier 12 and divided in frequency 13, then a fixed time delay is added by the delay line 14 before the output signal (TX OUT) is limited in amplitude via the limiting amplifier 15 and/or the variable attenuator 16. It is advantageous to use limiting amplification for the received signal to provide a high input dynamic range. The controller 18 is designed for setting the variable attenuator 16 depending on the power on the power detector 17. This provides a high linearity and has less broad-band noise. The amplitude control by the controller 18, as exemplified by measuring at a power detector 17 and adjusting the attenuation and/or amplification to adapt with respect to the original signal power, allows the simulator 10 to reproduce the radar cross-section or radar reflection properties of the target. In practical situations, radar targets exhibit diverse radar cross-section values, signifying discrepancies in how they reflect radar signals. The simulator 10 can fine-tune the amplitude of the simulated radar response via the limiting amplifiers 12, 15 and/or the variable attenuator 16 to correspond with the precise radar cross-section of the target in question. This precision is essential for faithfully replicating the appearance of various objects on a radar display, ensuring that the simulator can effectively emulate radar scenarios with accuracy and reliability.

In an alternative embodiment, the selection of a fixed time delay 14 offers versatility in tailoring the simulated object distance. A selection of the electric delay can be achieved through the utilization of a power divider and combiner combination or by employing electro-magnetic switches. By doing so, operators can select a variable radar signal path within a coaxial line, ranging from just a few centimeters to several meters, providing a flexible approach to controlling 18 delay times for various scenarios. When the signal is simultaneously routed through multiple paths with varying delays, this approach effectively replicates a target of specific dimensions at a distance via the designated delay range. By utilizing this multi-path setup, the radar target simulator 10 can precisely mimic the characteristics of a target, taking into account both its physical size and the distance via the distinct value respectively the range or extent of radar signal delays. In particular, it is possible to combine the electrical and optical delay paths in a way to simulate objects for instance with few meters extend a few hundred meters or kilometers away.

In scenarios demanding extended delays beyond several meters, an optimal solution is to employ an electro-optical converter for signal conversion into the optical domain before creating an optical delay. This approach involves the selection of optical delay lines in the form of for instance fiber elements, providing the capability for significantly longer delays ranging from several meters to kilometers. As the signal traverses these fiber delay lines, it is subsequently reconverted into electrical signals with an opto-electronic converter after the fiber delay. This method offers distinct advantages, particularly when extensive delay lengths are required, without compromising signal quality or amplitude. Notably, it incurs very minimal signal loss (a few decibels) and reduces or eliminates electromagnetic interference noise. This precision and adaptability in radar applications ensure that the system can effectively handle scenarios necessitating extended delays combined with increased, interference-free signal concentration, making it a valuable asset for radar testing and calibration in a variety of settings.

Most preferable is the use of Small Form-Factor Pluggable (SFP) hardware modules for generating the delays of the radar signals 10. Embodiments can also include the use of custom modules for other specific frequency bands and opto-electronic conversion or optical delay generation for LiDAR signals.

In an embodiment, the radar target simulator 10 employs a frequency divider 13 to reduce its signal bandwidth. This employment of a frequency divider 13 involves the division of the input signal's frequency 11, resulting in a noticeable reduction in the overall signal bandwidth. This functionality proves particularly advantageous for the simulator when it comes to replicating radar responses from targets characterized by specific bandwidth attributes. By narrowing down the signal bandwidth, the simulator becomes adept at accurately mimicking a diverse array of target scenarios.

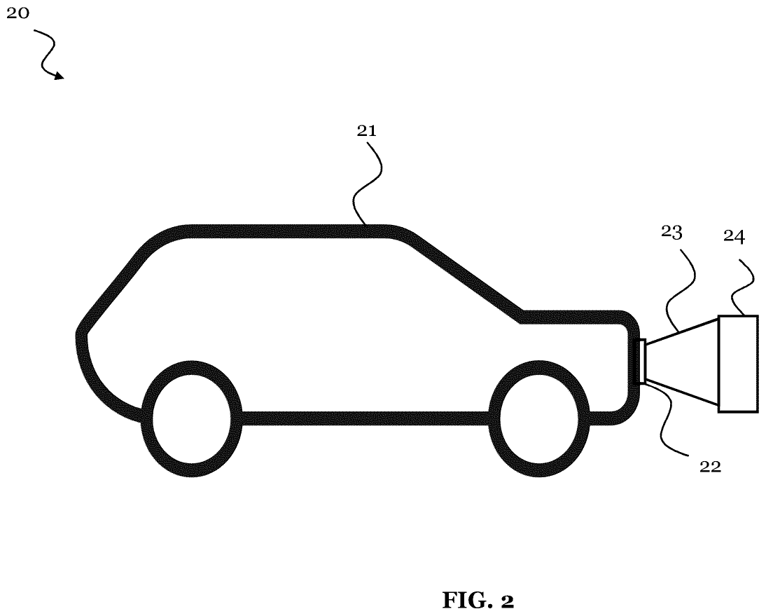

FIG. 2 shows a schematic of a setup of a vehicle radar sensor test 20, with a vehicle 21, a mount on the front radar sensor unit 22, a shielded radar environment 23 and a receiving antenna array 24.

In an embodiment of this, the radar target simulator is directly mounted 22 on the front of a car 21 with the help of a shielding cavity 23 such that the receiver and delay circuits can directly connect to the front-end of an antenna array 24. A shielded environment 23 radar test setup for cars 21 is typically used to assess the performance and reliability of automotive radar systems in controlled, interference-free conditions or for sensor certification. The shielded chambers 23 provide an electromagnetic-quiet environment, isolating the test vehicle from external radio frequency interference, and allowing engineers to conduct precise testing of radar sensors and their interactions with the vehicle's surroundings. This controlled environment is essential for validating radar-based features such as adaptive cruise control, collision avoidance, and parking assistance systems, ensuring their accurate and safe operation in practical scenarios.

Without restricting the applicability of this example, it's worth noting that the test setup for radar sensor units can also be placed on the rear or sides of the vehicle, thus offering increased testing versatility.

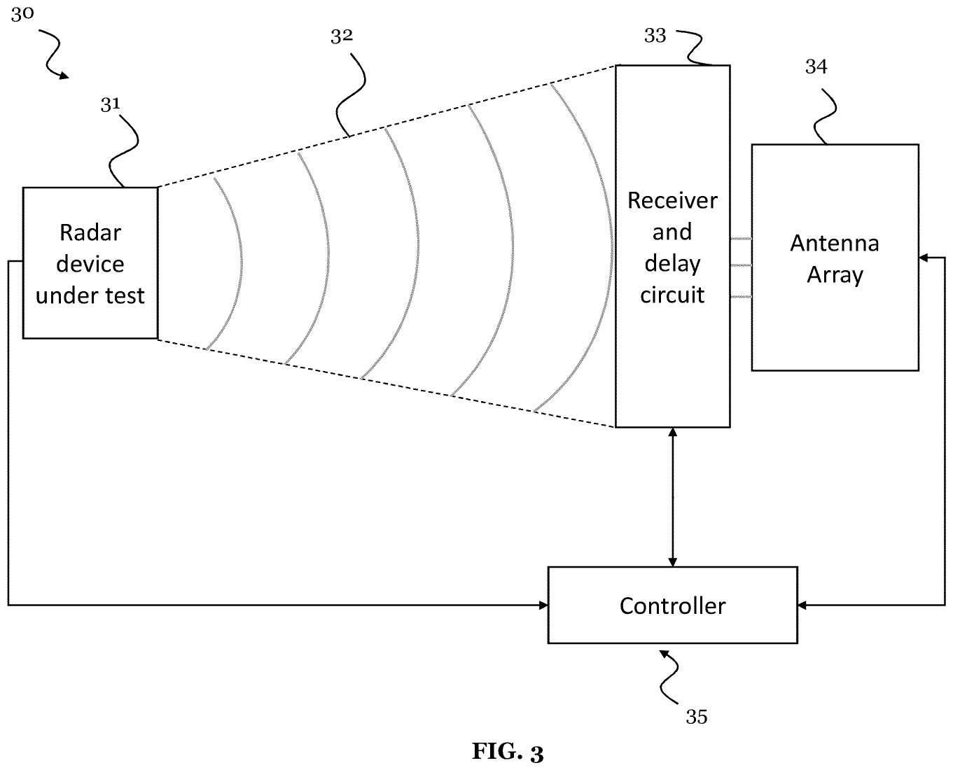

FIG. 3 shows a schematic of a radar system test setup 30, with a radar device under test 31, a shielded radar environment 32, a receiver and delay circuit 33 connected to an antenna array 34 and a controller 35.

In this test setup embodiment, the radar target simulator 30 offers the advantage of customized time delays for each simulated object, all of which can be precisely programmed by the controller 35. This approach leverages hardware-defined delays based on the path length or fiber length, enabling the sensor under test 31 to determine these delays with exceptional accuracy, achieving sub-nanosecond precision for non-digital time-delays. The flexibility of this design is notable, as it allows for a wide range of simulated delays, from very short distances, measured in centimeters, to extensive distances spanning kilometers, making it adaptable to various radar testing scenarios. By offering a modular set of time delay circuits 33 tailored to specific testing requirements, this system 30 proves to be cost-effective and space-efficient, eliminating the need to incorporate all possible options within a single device. This adaptability ensures that the simulator is optimized for the unique demands of each radar test scenario, making it a versatile and efficient tool for radar testing and calibration.

According to one embodiment, the controller first configures the radar device under test to emit radar and/or LiDAR signals, which are transmitted in a wave-like manner to scan the test environment 32. The receivers then accept, convert, condition, and limit the incoming signals using the delay circuits 33 before feeding them in an adapted form into the antenna array 34. Subsequently, the delay circuits 33 reemit the signals, simulating moving targets or stationary objects at variable distances as determined by the controller 35 settings and the information acquired from the radar signals at the antenna array 34, while also implementing amplitude limitations and time- or frequency-shift adjustments.

In another embodiment the target simulator introduces a frequency shift by using a mixer or generator prior to a return signal. The return signal then can effectively simulate the Doppler effect, which occurs when radar waves interact with moving targets. By precisely modulating the signal's frequency to mimic relative motion between the radar source and target, the simulator replicates the change in frequency of radio waves reflected off a moving target. This capability allows for the accurate simulation of varying target velocities, making the radar target simulator a valuable tool for testing and calibration of Doppler radar or FMCW Radar systems.

In another embodiment, the radar target simulator offers the capability to simulate a dynamic response akin to FMCW (Frequency-Modulated Continuous Wave) radar systems by implementing a continuous, time-dependent frequency shift. This emulation involves the deliberate alteration of the transmitted signal's frequency over time, mirroring the essential behavior of FMCW radar systems, including the generation of frequency beat notes. This dynamic frequency modulation serves a possible element in FMCW target simulation, ensuring the system's capacity for precise, versatile, and comprehensive testing and calibration of FMCW radar systems to replicate real-world scenarios accurately.

In an embodiment multiple channels of the antenna array 34 can multiplex into the same delay line and receiver circuit 33. This technique allows for efficient use of resources and simplifies the system architecture. By sharing a common delay line and/or receiver circuit 33, the radar target simulator can reduce the overall hardware complexity, which is particularly valuable in applications where space and cost considerations are paramount. Furthermore, it enhances the system's flexibility, enabling the simultaneous reception and processing of signals from multiple antenna elements. In this approach, each antenna element in the array 34 can be operated with its corresponding set of time delay circuits 33, allowing for precise control of the phase and time delay of the signals they transmit and receive. By controlling these time delays, the radar target simulator can steer its beam electronically without the need for physically moving the antennas. This capability enables rapid and agile beamforming, making it possible to track multiple targets simultaneously or focus on specific areas of interest. Moreover, the multiplexing of delays provides adaptability to changing operational requirements and signal interference mitigation.

In an alternative embodiment, a mixer is employed to perform up and down-conversion operations within the intermediate frequency path for instance of the antenna array system 34. This mixer serves the purpose of adjusting the radar signal received from the sensor unit under test 31, aligning it with the requirements of the signal processing components, including the acquisition ADC (Analog-to-Digital Converter), and the signal generation components, such as the generation DAC (Digital-to-Analog Converter), integrated into the array hardware 34. This critical step ensures seamless compatibility and optimal signal flow within the array hardware 34, allowing for precise data acquisition and signal generation processes that are essential for radar testing and calibration. By incorporating a mixer, the system achieves efficient signal handling on various frequency bands, contributing to the overall functionality and accuracy of the radar target simulator.

In an embodiment, the controller's role 35 extends beyond the setting of signal conditioning; it actively manages the radar and/or LiDAR signals' interaction with the antenna array 34. By adjusting the controller's settings, the radar target simulator can simulate a wide range of target scenarios, including objects at varying distances, differing speeds, and distinct reflection characteristics. The antenna array 34, in conjunction with the controller 35, enables the precise control, combination and reemission of multiple signals (up to 100). The dynamic data acquisition, selection and control over a plurality of signals facilitates realistic target simulation by generating reemitted signals with specific time- or frequency-shifts, accurately replicating the behavior of several moving targets or stationary objects within the test environment. The co-integration of the controller 35 and antenna array 34 allows for sophisticated radar testing, providing valuable insights into the radar system's performance and its ability to detect, track, and respond to various target conditions.

All features explained in connection with individual embodiments of the present disclosure may be implemented in different combinations in the disclosed subject-matter in order to simultaneously realize their advantageous effect. The scope of protection of the present disclosure is given by the patent claims and is therefore not limited by the features explained in the description or shown in the figures.

1. A delay circuit, comprising:
a) receiver for an incoming signal;
b) an input power detector;
c) a power controlling circuit; and
d) a delay line configured to introduce a predetermined time delay to the signal,
wherein the delay circuit is adapted to provide an output by introducing a con-trolled time delay and power setting to said incoming signal.

2. The delay circuit of claim 1,
comprising an attenuator or a further amplifier downstream the fixed delay line, and controlled to reestablish an original signal power of the incoming signal.

3. The delay circuit of claim 1,
wherein the delay line includes a PCB transmission line, coaxial cable, or fiber.

4. The delay circuit of claim 1,
wherein the signal is a ranging system signal or a non-ranging signal.

5. The delay circuit of claim 1,
wherein the signal is one of a radar, sonic, photonic, RF, TOF camera, and/or LiDAR signal.

6. The delay circuit of claim 1, wherein the limiting amplifier is adapted to limit the amplitude of the incoming signal to simulate the radar cross-section of a target.

7. The delay circuit of claim 1,
further comprising a controller configured to adjust the time delay and amplitude limitation parameters based on a user-defined input to simulate various radar target scenarios.

8. The delay circuit of claim 1,
further comprising a frequency divider before the delay line.

9. The delay circuit of claim 8,
wherein a signal bandwidth is restored with a frequency multiplier in a TX Path.

10. The delay circuit of claim 3,
further comprising an opto-electronic converter prior to and after a fiber delay.

11. The delay circuit of claim 1,
further comprising multiple delay lines in the delay circuit and a switch for selecting the predetermined time delay.

12. The delay circuit system of claim 11,
where the multiple delay lines comprise short delay lines which are coaxial and long delay lines which are fiber-based.

13. The delay circuit of claim 1,
where the target simulator applies a frequency shift to a return signal.

14. The delay circuit of claim 1,
where each object to be simulated has a separate delay line.

15. The delay circuit system of claim 1,
wherein multiple channels of an antenna array multiplex into the same delay line.

16. The delay circuit of claim 1,
further comprising a mixer to adapt the frequencies as a downconverter and upconverter from the intermediate frequency path.

17. A Radar target simulator comprising a delay circuit, wherein the delay circuit comprises:
a) receiver for an incoming signal;
b) an input power detector;
c) a power controlling circuit; and
d) a delay line configured to introduce a predetermined time delay to the signal,
wherein the delay circuit is adapted to provide an output by introducing a con-trolled time delay and power setting to said incoming signal.

18. The Radar target simulator of claim 17,
wherein the delay circuit further comprises an attenuator or a further amplifier downstream the fixed delay line, and controlled to reestablish an original signal power of the incoming signal.

19. The Radar target simulator of claim 17,
wherein the delay line includes a PCB transmission line, coaxial cable, or fiber.

20. The Radar target simulator of claim 17,
wherein the signal is a ranging system signal or a non-ranging signal.
